(19) United States
(12) Patent Application Publication
(10) Pub. No.: US 2023/0144219 A1
(43) Pub. Date: May 11, 2023

(54) ELECTRONIC DEVICE

(71) Applicant: Samsung Display Co., Ltd., Yongin-si (KR)

(72) Inventors: HEEYOUNG LEE, Hwaseong-si (KR); MINKYOUNG JUNG, Asan-si (KR); EUNMI SEO, Cheonan-si (KR); JI-HOON KIM, Hwaseong-si (KR); MINJU OH, Suwon-si (KR)

(21) Appl. No.: 17/900,278

(22) Filed: Aug. 31, 2022

(30) Foreign Application Priority Data
Nov. 5, 2021 (KR) 10-2021-0151333

(51) Int. Cl. H04M 1/02; H05K 5/03

(52) U.S. Cl. CPC H04M 1/0268; H05K 5/03; H04M 1/0214

(57) ABSTRACT

An electronic device includes an electronic module, a display module including a first region overlapping the electronic module, and a second region not overlapping the electronic module, a window module disposed on the display module, and a coating layer disposed on at least one of a first outermost surface of the window module opposite to a second outermost surface of the window module facing the display module and a first outermost surface of the display module opposite to a second outermost surface of the display module facing the window module.

This application claims priority to Korean Patent Application No. 10-2021-0151333, filed on Nov. 5, 2021, and all the benefits accruing therefrom under 35 U.S.C. § 119, the content of which in its entirety is herein incorporated by reference.

### BACKGROUND

### 1. Field

Embodiments of the invention herein relate to an electronic device, and more particularly, to an electronic device including a camera module under a display module.

### 2. Description of the Related Art

To provide video information, various types of electronic devices are being used, and an electronic device may include an electronic module which receives an external signal, or supplies an output signal to the outside. The electronic module may include a camera module, or the like, for example, and demands for electronic devices capable of achieving a high-quality captured image are increasing.

To increase a region, in which a video is displayed, in the electronic device, it is contemplated to arrange a camera module or the like in a region in which a video is displayed, and accordingly, it is desired to improve the quality of a captured video.

### SUMMARY

Embodiments of the invention provide an electronic device with improved sensing performance of an electronic module disposed under a display module.

Embodiments of the invention also provide an electronic device with improved display quality of an image captured by a camera module disposed under a display module.

An embodiment of the invention provides an electronic device including an electronic module, a display module including a first region overlapping the electronic module, and a second region not overlapping the electronic module, a window module disposed on the display module, and a coating layer disposed on at least one of a first outermost surface of the window module opposite to a second outermost surface of the window module facing the display module and a first outermost surface of the display module opposite to a second outermost surface of the display module facing the window module.

In an embodiment, the coating layer may have an average thickness of about 10 nanometers (nm) to about 10000 nm.

In an embodiment, the coating layer may have a refractive index between a refractive index of an outermost layer of the window module including the first outermost surface and a refractive index of air, or between a refractive index of an outermost layer of the display module including the first outermost surface of the display module and the refractive index of air.

In an embodiment, the coating layer may have a refractive index of about 1.0 to about 1.6.

In an embodiment, an entirety of the display module, the window module, and the coating layer which are stacked may have a haze of about 4.5 percent (%) or less.

In an embodiment, the coating layer may include an acryl-based resin, a siloxane-based resin, or a composite resin derived from a combination of the acryl-based resin and the siloxane-based resin.

In an embodiment, the window module may include a window, a protective layer disposed on a first surface of the window and including the first outermost surface opposite to the first surface of the window, and a window adhesive layer disposed on a second surface of the window opposite to the first surface of the window and facing the display module, and the coating layer may be disposed on at least one of the first outermost surface of the protective layer and the first outermost surface of the display module.

In an embodiment, the display module may include a display panel, and a first film disposed on a first surface of the display panel opposite to a second surface of the display panel facing the window module and including the first outermost surface of the display module, and the coating layer may be disposed on at least one of the first outermost surface of the window module and the first outermost lower surface of the first film.

In an embodiment, the display module may further include a second film disposed on the second surface of the display panel.

In an embodiment, the first film and the second film may be each a polymer film independently including polyethyleneterephthalate (“PET”), or polyimide (“PI”).

In an embodiment, the display module may include a display panel, and a first film which is disposed on a first surface of the display panel opposite to a second surface of the display panel facing the window module and includes the first outermost surface of the display module, the window module may include a window, a protective layer which is disposed on a first surface of the window and includes the first outermost surface of the window module, and a window adhesive layer disposed on a second surface of the window opposite to the first surface of the window and facing the display module, and the coating layer may include a first coating layer disposed on the first outermost surface of the first film, and a second coating layer disposed on the first outermost surface of the protective layer.

In an embodiment, the display module may further include a second film disposed on the second surface of the display panel.

In an embodiment, the window may be a cover window including a glass material, and the protective layer may include thermoplastic polyurethane (“TPU”), or PET.

In an embodiment of the invention, an electronic device, which is divided into a folding region folded with respect to a folding axis extending in a direction, and a non-folding region adjacent to the folding region, includes an electronic module, a display panel including a first region overlapping the electronic module, and a second region not overlapping the electronic module, a window module disposed on a first surface of the display panel, a film disposed on a second surface of the display panel opposite to the first surface of the display panel, and a coating layer disposed on at least one of a first surface of the window module opposite to a second surface of the window module facing the display panel and a first surface of the film opposite to a second surface of the film facing the window module.

In an embodiment, the coating layer may have an average thickness of about 10 nm to about 10000 nm.

In an embodiment, the coating layer may have a refractive index of about 1.0 to about 1.6.

In an embodiment, an entirety of the display panel, the window module, the film, and the coating layer which are stacked may have a haze of about 4.5% or less.

In an embodiment of the invention, an electronic device includes an electronic module, a support module in which a through-hole is defined and which overlaps the electronic module, and a display member disposed on the support module, and including a display module, a window module disposed on the display module, and a coating layer disposed on at least one of a first outermost surface of the window module opposite to a second outermost surface of the window module facing the display module and a first outermost surface of the display module opposite to a second outermost surface of the display module facing the window module, wherein the display member has a haze of about 4.5% or less.

In an embodiment, the display module may include a display panel, and a film disposed on a first surface of the display panel opposite to a second surface of the display panel facing the window module, the window module may include a window including a glass material, a protective layer disposed on a first surface of the window, and a window adhesive layer disposed on a second surface of the window opposite to the first surface of the window and facing the display module, and the coating layer may include a first coating layer disposed on a first surface of the protective layer opposite to a second surface of the protective layer facing the display module, and a second coating layer disposed on a first surface of the film opposite to a second surface of the film facing the window module.

In an embodiment, the first coating layer and the second coating layer may each have an average thickness of about 10 nm to about 10000 nm.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain principles of the invention. In the drawings:

FIG. 1A is a perspective view illustrating an embodiment of the unfolded state of an electronic device;

FIG. 1B is a perspective view illustrating an embodiment in which an electronic device is being in-folded;

FIG. 1C is a perspective view illustrating that an electronic device in an embodiment is being out-folded;

FIG. 2 is an exploded perspective view of an embodiment of an electronic device;

FIG. 3 is a cross-sectional view of an embodiment of an electronic device;

FIG. 4A is a cross-sectional view illustrating an embodiment of a part of an electronic device;

FIG. 4B is a cross-sectional view illustrating an embodiment of a part of an electronic device; and

FIG. 5 is a diagram illustrating an embodiment of a part in which a coating layer in an embodiment is disposed.

### DETAILED DESCRIPTION

In the embodiments of the invention, various modifications may be made and various forms may be applied, and illustrative embodiments will be illustrated in the drawings and described in detail in the text. However, this is not intended to limit the invention to a specific disclosure form, and it should be understood to include all changes, equivalents, and substitutes included in the spirit and scope of the invention.

In this specification, when a component (or region, layer, portion, etc.) is referred to as “on”, “connected”, or “coupled” to another component, it means that it is placed/connected/coupled directly on the other component or a third component can be disposed between them.

In the application, “directly in contact” may mean that there is no layer, film, region, plate, etc., added between a portion such as a layer, film, region, or plate and another portion. A term such as “direct contact” may mean placing two layers or two members without using an additional member such as an adhesive member therebetween, for example.

The same reference numerals or symbols refer to the same elements. In addition, in the drawings, thicknesses, ratios, and dimensions of components are exaggerated for effective description of technical content. “And/or” includes all combinations of one or more that the associated elements may define.

Terms such as first and second may be used to describe various components, but the components should not be limited by the terms. These terms are only used for the purpose of distinguishing one component from other components. Without departing from the scope of the invention, a first component may be referred to as a second component, and similarly, a second component may be referred to as a first component, for example. Singular expressions include plural expressions unless the context clearly indicates otherwise.

In addition, terms such as “below”, “lower”, “above”, and “upper” are used to describe the relationship between components shown in the drawings. The terms are relative concepts and are described based on the directions indicated in the drawings.

Terms such as “include” or “have” are intended to designate the presence of a feature, number, step, action, component, part, or combination thereof described in the specification, and it should be understood that it does not preclude the possibility of presence or addition of one or more other features, numbers, steps, operations, components, parts, or combinations thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term “about” can mean within one or more standard deviations, or within ±30%, 20%, 10%, 5% of the stated value, for example.

Unless otherwise defined, all terms (including technical and scientific terms) used in this specification have the same meaning as commonly understood by one of ordinary skill in the art to which this invention belongs. In addition, terms such as terms defined in commonly used dictionaries should be interpreted as having a meaning consistent with the meaning having in the context of the related technology, and should not be interpreted as too ideal or too formal unless explicitly defined here.

Hereinafter, an electronic device in an embodiment of the invention will be described with reference to the drawings.

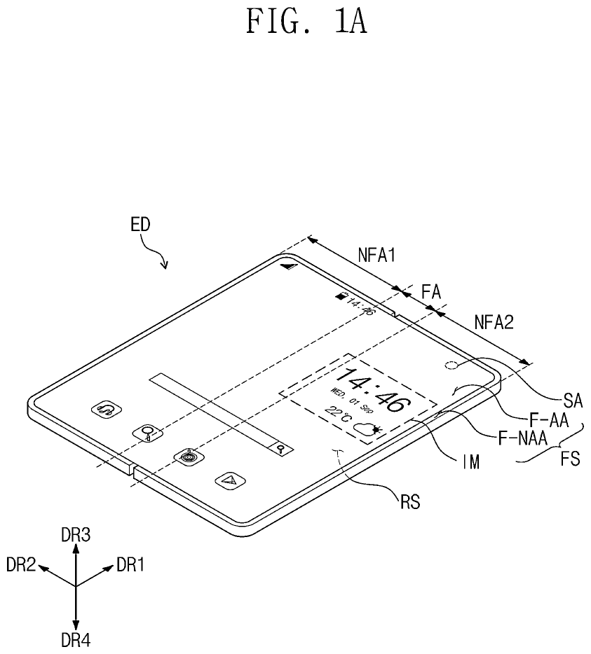

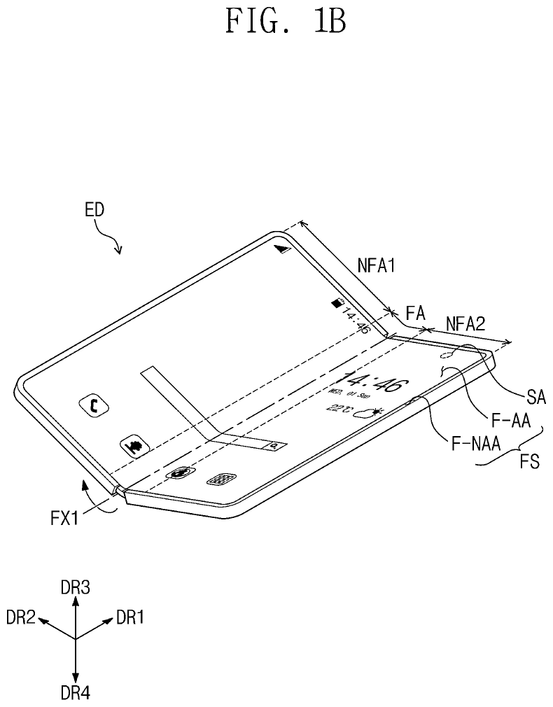

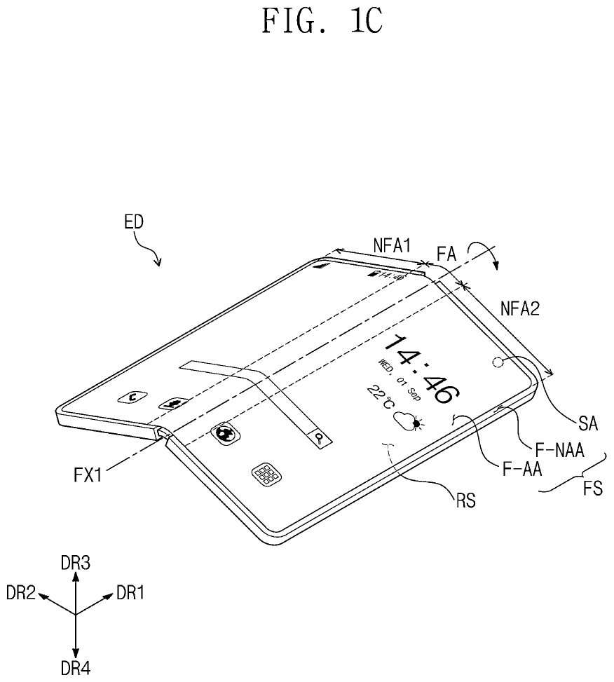

FIG. 1A is a perspective view illustrating an embodiment of a state in which an electronic device is unfolded. FIG. 1B is a perspective view illustrating that an electronic device illustrated in FIG. 1A is being in-folded. FIG. 1C is a perspective view illustrating that the electronic device illustrated in FIG. 1A is being out-folded.

An electronic device ED in an embodiment may be a device activated in response to an electric signal. In an embodiment, the electronic device ED may be a mobile phone, a tablet computer, a car navigation system, a game console, or a wearable device, but the invention is not limited thereto. In the disclosure, for example, in FIG. 1A, a mobile phone is illustrated in an embodiment of the electronic device ED.

FIGS. 1A to 1C illustrate, as the electronic device ED, a foldable electronic device which may be folded and change the form thereof, but the invention is not limited thereto. The electronic device ED in an embodiment may be a flexible electronic device of which the form may be changed by bending, or rolling.

In FIG. 1A and the following drawings, a first directional axis DR1 to a fourth directional axis DR4 are illustrated, and directions indicated by the first to fourth directional axes DR1, DR2, DR3, and DR4 described herein are relative concepts, and may be changed to other directions. In addition, the directions indicated by the first to fourth directional axes DR1, DR2, DR3, and DR4 may be described as first to fourth directions, and may use the same reference numbers or symbols.

Referring to FIGS. 1A to 1C, the electronic device ED in an embodiment may include a display surface FS defined by the first directional axis DR1 and the second directional axis DR2 crossing the first directional axis DR1. The electronic device ED may supply an image IM to a user through the display surface FS. The electronic device ED in an embodiment may display, toward a third directional axis DR3, the image IM on the display surface FS parallel to the first directional axis DR1 and the second directional axis DR2. In the disclosure, the front surface (or upper surface) and the rear surface (or lower surface) of each component are defined with respect to a direction in which the image IM is displayed. In the disclosure, a direction in which the image IM is displayed may be defined as the third directional axis DR3, and the fourth directional axis DR4 may be defined as a direction opposing the direction of the third directional axis DR3.

The electronic device ED in an embodiment may sense an external input applied from the outside. The external input may include various types of inputs supplied from the outside of the electronic device ED. In an embodiment, the external input may include not only a touch by a part of a body such as a user's hand, but also an external input (e.g., hovering) applied in proximity to the electronic device ED or adjacent to the electronic device ED within a predetermined distance, for example. In addition, the external input may have various forms such as force, pressure, temperature, and light.

The display surface FS of the electronic device ED may include an active region F-AA and a peripheral region F-NAA. The active region F-AA may be a region activated in response to an electric signal. The electronic device ED in an embodiment may display the image IM through the active region F-AA. In addition, the active region F-AA may sense various types of external inputs. The peripheral region F-NAA is adjacent to the active region F-AA. The peripheral region F-NAA may have a predetermined color. The peripheral region F-NAA may surround the active region F-AA. Accordingly, the shape of the active region F-AA may be substantially defined by the peripheral region F-NAA. However, this is merely one of embodiments, and in an alternative embodiment, the peripheral region F-NAA may be disposed adjacent to only one side of the active region F-AA, or may be omitted. The electronic device ED in an embodiment of the invention may include various shapes of active regions, but the invention is not limited thereto.

The active region F-AA may include a sensing region SA. Various electronic modules may be disposed in the sensing region SA. In an embodiment, the electronic modules may include at least one of a camera module, a speaker, a light-sensing sensor and a heat-sensing sensor, for example. The sensing region SA may sense an external subject received through the display surface FS, or supply a sound signal such as voice to the outside through the display surface FS. The electronic modules may include a plurality of components, but the invention is not limited thereto.

In an embodiment, the sensing region SA may be surrounded by the active region F-AA and the peripheral region F-NAA, but the invention is not limited thereto. In an embodiment, the sensing region SA may be disposed in the active region F-AA, but the invention is not limited thereto. In the illustrated embodiment, the electronic device ED includes one sensing region SA, but the number of the sensing region SA is not limited thereto.

The sensing region SA may be a part of the active region F-AA. Accordingly, the electronic device ED may also display a moving image (e.g., video) on the sensing region SA. When electronic modules disposed in the sensing region SA are inactivated, the sensing region SA may serve as a display surface and display a video or image.

A rear surface RS of the electronic device ED in an embodiment may be a surface facing the display surface FS. In an embodiment, the rear surface RS is an external surface of the electronic device ED, and may not display a video or image. However, the invention is not limited thereto, and the rear surface RS may function as a second display surface displaying a video or an image. In addition, the electronic device ED in an embodiment may further include a sensing region disposed on the rear surface RS. A camera, a speaker, a light-sensing sensor, etc., may be disposed in the sensing region disposed on the rear surface RS.

The electronic device ED may include a folding region FA, and non-folding regions NFA1 and NFA2. The electronic device ED may include a plurality of non-folding regions NFA1 and NFA2. The electronic device ED in an embodiment may include a first non-folding region NFA1 and a second non-folding region NFA2 disposed with the folding region FA therebetween. FIGS. 1A to 1C illustrate an embodiment of the electronic device ED including one folding region FA, but the invention is not limited thereto. A plurality of folding regions may be defined in the electronic device ED, but the invention is not limited thereto. The electronic device ED in an embodiment may be folded with respect to a plurality of folding axes so that parts of the display surface FS may face each other, and the number of the folding axes and thus the number of non-folding regions are not particularly limited.

Referring to FIGS. 1B and 1C, the electronic device ED in an embodiment may be folded with respect to a folding axis FX1. The folding axis FX1 illustrated in FIGS. 1B and 1C is a virtual axis extending in the first directional axis DR1, and may be parallel to a long side direction of the electronic device ED. However, the invention is not limited thereto, and the extension direction of the folding axis FX1 is not limited to the first directional axis DR1.

The folding axis FX1 may extend along the first directional axis DR1 on the display surface FS, or may extend along the first directional axis DR1 under the rear surface RS. Referring to FIG. 1B, in an embodiment, the first non-folding region NFA1 and the second non-folding region NFA2 may face each other, and the electronic device ED may be in-folded such that the display surface FS is not exposed to the outside. In addition, referring to FIG. 1C, the electronic device ED in an embodiment may be out-folded with respect to the folding axis FX1 so that one region of the rear surface RS overlapping the first non-folding region NFA1 and another region of the rear surface RS overlapping the second non-folding region NFA2 face each other.

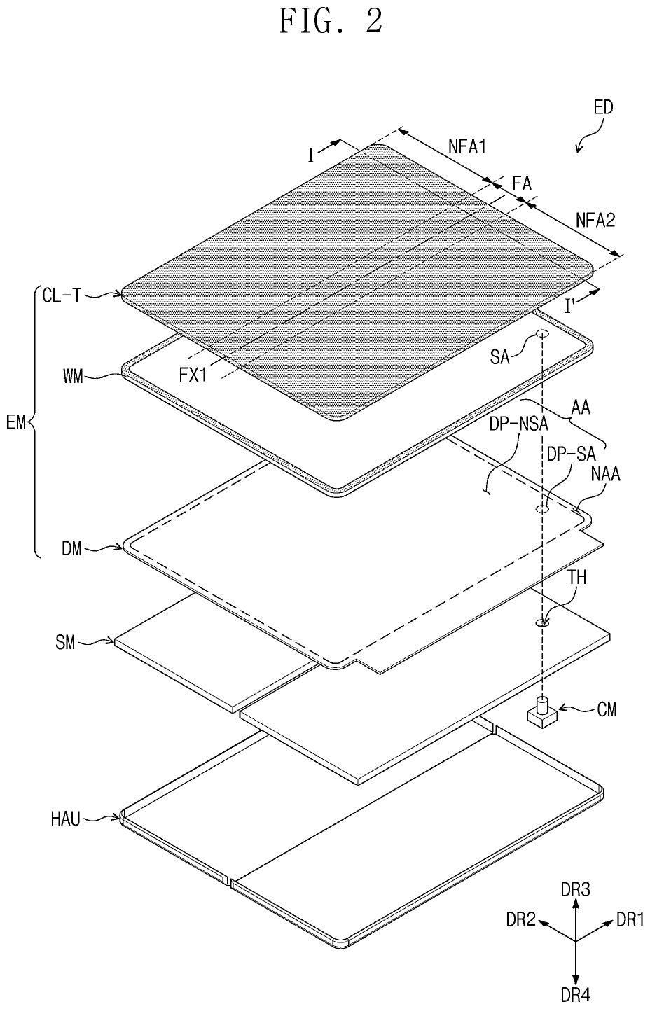

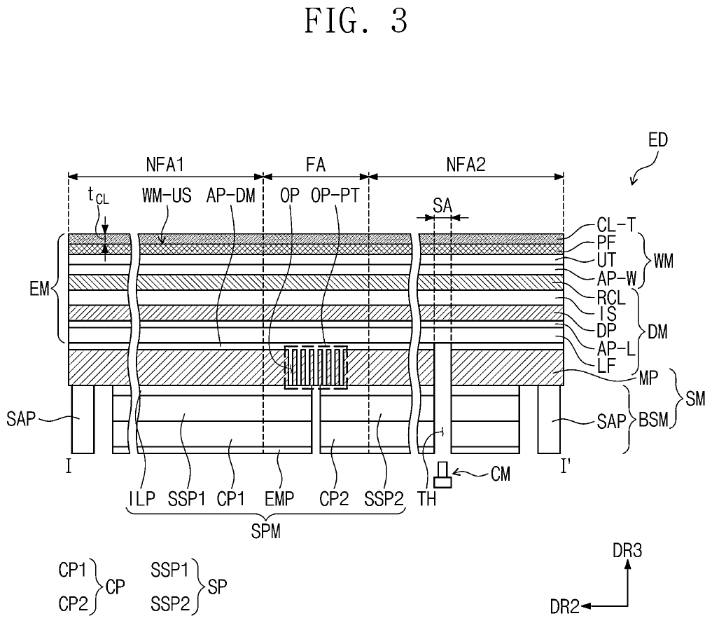

FIG. 2 is an exploded perspective view of an embodiment of an electronic device, and FIG. 3 is a cross-sectional view of an embodiment of an electronic device. FIG. 2 illustrates an exploded perspective view of an electronic device in an embodiment illustrated in FIG. 1A. FIG. 3 is a cross-sectional view illustrating a part taken along line I-I′ of FIG. 2.

Referring to FIGS. 2 and 3, an electronic device ED in an embodiment may include an electronic module CM, a display module DM, a window module WM, and an upper coating layer CL-T. In addition, the electronic device ED in an embodiment may include a support module SM disposed under the display module DM.

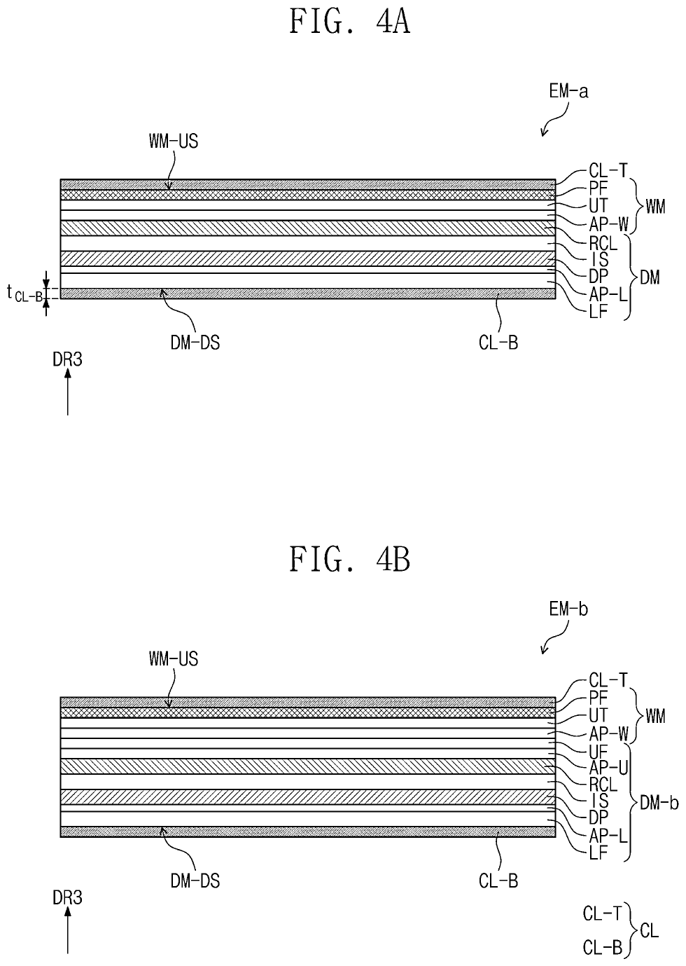

The entire stacked structures disposed on the electronic module CM may be referred to as a display member EM. The display member EM may include the display module DM, the window module WM, and the coating layer CL (refer to FIG. 4A) disposed under the display module DM, and/or on the window module WM. The coating layer CL may include at least one of the upper coating layer CL-T disposed on the window module WM and a lower coating layer CL-B (refer to FIG. 4A) disposed under the display module DM. Hereinafter, for convenience, each or all of the upper coating layer CL-T and the lower coating layer CL-B (refer to FIG. 4A) may be also referred to as a coating layer. FIGS. 2 and 3 illustrate the electronic device ED including the upper coating layer CL-T disposed on the window module WM in an embodiment, and the upper coating layer CL-T will be described as a coating layer in the description of FIGS. 2 and 3.

Referring to FIGS. 2 and 3, at least one of the uppermost surface and the lowermost surface of the display member EM in the electronic device ED in an embodiment may be one surface of the upper coating layer CL-T. FIGS. 2 and 3 illustrate that the upper coating layer CL-T is disposed on the window module WM, but the invention is not limited thereto. The electronic device ED in an embodiment including the coating layer CL which is an uppermost layer defining the uppermost surface of the display member EM and/or a lowermost layer defining the lowermost surface of the display member EM may reduce light scattering caused by the rough surface of the window module WM, thereby improving the sensitivity and performance of the electronic module CM. Particularly, the electronic device ED in an embodiment including a camera module as the electronic module CM may include the coating layer CL including a surface as the outermost surface of the display member EM, thereby reducing haze caused by light scattering on the outer surface of the display member EM, and showing excellent captured imaging quality. That is, in the electronic device ED in an embodiment, at least one of the uppermost surface of the window module WM and the lowermost surface of the display module DM in the sensing region SA overlapping the electronic module CM may be covered with the coating layer CL, thereby minimizing scattering of a light signal incident on or emitted from the electronic module CM.

Referring to FIG. 3, the window module WM may include a window UT, a protective layer PF, and a window adhesive layer AP-W. In an alternative embodiment, the protective layer PF may be omitted.

The display module DM may be disposed under the window module WM. The window module WM may cover the entire upper surface of the display module DM. The window module WM may have a shape corresponding to the shape of the display module DM.

The window UT may include an optically transparent insulating material. The window UT may be a glass substrate, or a polymer substrate. In an embodiment, the window UT may be a tempered glass substrate, for example. In addition, the window UT may be sufficiently thin to enable a folding operation. The window UT may be an ultrathin glass (“UTG”) substrate. The window UT may include a glass material to be used as a cover window in an electronic device.

The protective layer PF may be disposed on the window UT. The protective layer PF may be a functional layer that protects the upper surface of the window UT.

In an embodiment, the protective layer PF in an embodiment may be a polymer film including at least one polymer resin of polyethyleneterephthalate (“PET”), polybutyleneterephthalate (“PBT”), polyethylenenaphthalene (“PEN”), polycarbonate (“PC”), poly(methylmethacrylate) (“PMMA”), polystyrene (“PS”), polyvinylchloride (“PVC”), polyethersulfone (“PES”), polypropylene (“PP”), polyamide (“PA”), modified polyphenyleneether (“m-PPE”), modified polyphenyleneoxide (“m-PPO”), polyoxymethylene (“POM”), polysulfone (“PSU”), polyphenylenesulfide (“PPS”), polyimide (“PI”), polyethyleneimine (“PEI”), polyetheretherketone (“PEEK”), polyamideimide (“PAI”), polyarylate (“PAR”), and thermoplastic polyurethane (“TPU”).

In an embodiment, the protective layer PF may be a PET film, or a thermoplastic polyurethane (“TPU”) film, for example. In addition, the protective layer PF may be a PET film having no phase retardation.

The window module WM may further include a protective layer-bonding layer (not shown). The protective layer-bonding layer (not shown) may be disposed between the window UT and the protective layer PF. The protective layer PF may be bonded on the window UT by the protective layer-bonding layer (not shown). The protective layer-bonding layer (not shown) may include a silicon-based resin, an acryl-based resin, or a urethane-based resin. In addition, the protective layer PF may further include an anti-fingerprint coating agent, an antistatic agent, a hard coating agent, etc., thereby serving as a functional layer. The protective layer PF may have a multi-layered stack structure, and may further include a separate functional layer such as an anti-fingerprint coating layer, an antistatic layer, and a hard coating layer.

In an embodiment, the window adhesive layer AP-W may be an optically clear adhesive film (“OCA”), or an optically clear adhesive resin layer (“OCR”).

The upper coating layer CL-T including a surface, which defines the upper surface of the display member EM in the electronic device ED in an embodiment, may be disposed on the uppermost surface WM-US of the window module WM. When the window module WM includes the protective layer PF, the upper coating layer CL-T may be directly disposed on the upper surface of the protective layer PF. In an alternative embodiment, when the window module WM does not include the protective layer PF, the upper coating layer CL-T may be directly disposed on the upper surface of the window UT.

When the upper coating layer CL-T is disposed on the display member EM, the upper coating layer CL-T may cover the surface roughness of the uppermost surface WM-US of the window module WM. In an embodiment, the upper coating layer CL-T may have an average thickness t_{CL} of about 10 nanometers (nm) to about 10000 nm. When the upper coating layer CL-T has an average thickness t_{CL} of less than about 10 nm, the upper coating layer CL-T may not sufficiently cover the roughness of the outer surface of the window module WM, thereby not sufficiently achieving improvement in haze. In addition, when the upper coating layer CL-T has an average thickness t_{CL} of more than about 10000 nm, the folding performance of the electronic device ED may be deteriorated due to the great thickness.

When the upper coating layer CL-T is disposed on the display member EM, the upper coating layer CL-T may have a refractive index between the refractive index of air and the refractive index of the uppermost layer of the window module WM in direct contact with the upper coating layer CL-T. In an embodiment, the upper coating layer CL-T may have a refractive index of about 1.0 to about 1.6, for example.

The upper coating layer CL-T may be an organic layer, an inorganic layer, or an organic-inorganic composite material layer. The upper coating layer CL-T may be an acryl-based resin, a siloxane-based resin, or a composite resin derived from a combination thereof. In an embodiment, the upper coating layer CL-T may include a composition for a hard coating layer, for example. However, in an alternative embodiment, the upper coating layer CL-T may not include a scattering body such as an inorganic particle to reduce haze.

The display module DM may be disposed under the window module WM. The display module DM may be a component generating a video and sensing an input applied from the outside. The electronic module CM may be disposed under the display module DM, and may be, for example, a camera module. The display module DM may be also referred to as a first electronic module, and the electronic module CM may be also referred to as a second electronic module.

The display module DM may display a video according to an electrical signal, and may transmit/receive information about an external input. Referring to FIGS. 2 and 3, the display module DM may include a display region AA and a non-display region NAA. The display region AA may be defined as a region that emits a video supplied by the display module DM.

The non-display region NAA is adjacent to the display region AA. In an embodiment, the non-display region NAA may surround the display region AA, for example. However, this is merely an illustrative embodiment, and the non-display region NAA may be defined in various shapes, and the invention is not limited thereto. In an embodiment, the display region AA of the display module DM may correspond to at least a part of the active region F-AA (refer to FIG. 1).

The display region AA of the display module DM may include a first region DP-SA overlapping the electronic module CM and a second region DP-NSA not overlapping the electronic module CM. In an embodiment, one region of the display module DM may have a higher transmittance than another region. In an embodiment, the first region DP-SA overlapping the electronic module CM may have a higher transmittance than that of the second region DP-NSA not overlapping the electronic module CM, for example. The first region DP-SA may display a video, and may transmit an external input supplied to the electronic module CM, and/or an output from the electronic module CM. The first region DP-SA may be a part of the display region AA, and may be also referred to as a sensing region. The first region DP-SA may correspond to the sensing region SA of the electronic device ED.

The display module DM may include a display panel DP, a sensor layer IS, and a reflection adjustment layer RCL. In an alternative embodiment, the sensor layer IS, the reflection adjustment layer RCL, or the like may be omitted.

The display panel DP may be a component that substantially generates a video. In an embodiment, the display panel DP may be an organic light-emitting display panel, an inorganic light-emitting display panel, a quantum dot display panel, a micro light-emitting diode (“micro-LED”) display panel, a nano-LED display panel, or a liquid crystal display panel, for example. The display panel DP may be also referred to as a display layer.

The sensor layer IS may be disposed on the display panel DP. The sensor layer IS may sense an external input applied from the outside. The external input may be a user's input. The user's input may include various forms of external inputs such as a part of a user's body, light, heat, a pen, or pressure.

The sensor layer IS in the display module DM in an embodiment may be formed or disposed on the display panel DP through a continuous process. In this case, it may be expressed that the sensor layer IS is directly disposed on the display panel DP. The wording, “being directly disposed” may mean that a third component is not disposed between the sensor layer IS and the display panel DP. That is, a separate adhesive member may not be disposed between the sensor layer IS and the display panel DP. In an alternative embodiment of the invention, the sensor layer IS may be bonded to the display panel DP through an adhesive member. The adhesive member may include a typical bonding agent or adhesive.

The reflection adjustment layer RCL may be disposed on the sensor layer IS. The reflection adjustment layer RCL may be disposed on the display panel DP to control reflection of external light at the display panel DP. That is, the reflection adjustment layer RCL may reduce reflectance of external light incident from the outside of the display module DM. The reflection adjustment layer RCL may include, for example, a polarization layer, a color filter layer, or a light converting agent such as pigment or dye. Unlike the embodiment illustrated in the drawing, in an alternative embodiment, the reflection adjustment layer RCL may be omitted in the display module DM.

The display module DM may include a lower film LF disposed under the display panel DP. The lower film LF may be disposed under the display panel DP to protect the lower portion of the display panel DP. The display module DM may include a lower adhesive layer AP-L that bonds the display panel DP and the lower film LF.

The lower film LF may be a polymer film. In an embodiment, the lower film LF may include a PET film or a PI film, for example. The lower film LF may prevent a scratch from occurring on the rear surface of the display panel DP during the manufacturing process of the display panel DP. In addition, the lower film LF may protect the display panel DP against pressure applied from the outside, thereby protecting deformation of the display panel DP. The lower film LF may have a structure which has one film layer, or in which a plurality of film layers is stacked.

The lower adhesive layer AP-L may be disposed between the display panel DP and the lower film LF. The lower adhesive layer AP-L may be an OCA, or an OCR. However, the invention is not limited thereto, and the lower adhesive layer AP-L may include an acryl-based adhesive, or a silicon-based adhesive. In an alternative embodiment, the lower adhesive layer AP-L may be omitted.

The electronic device ED in an embodiment may include a support module SM disposed under the display module DM. The support module SM may include a support plate MP and a lower support member BSM.

The support plate MP may be disposed under the display module DM. In an embodiment, the support plate MP may include a metal material or a polymer material. In an embodiment, the support plate MP may include stainless steel, aluminum, or an alloy thereof, for example. In another embodiment, unlike the aforementioned embodiment, the support plate MP may include carbon fiber reinforced plastic (“CFRP”), etc. However, the invention is not limited thereto, and the support plate MP may include a non-metal material, plastic, glass fiber reinforced plastic, or glass.

A plurality of openings OP may be defined in the support plate MP. The support plate MP may include an opening pattern OP-PT in which the plurality of openings OP is defined. The opening pattern OP-PT may correspond to the folding region FA.

The lower support member BSM may include a support member SPM and a filling part SAP. The support member SPM may be a part overlapping the most region of the display module DM. The filling part SAP may be a part disposed outside the support member SPM, and overlapping the outside of the display module DM.

The lower support member BSM may include at least one of a support layer SP, a cushion layer CP, a shield layer EMP and an inter-bonding layer ILP. The configuration of the lower support member BSM is not limited to the embodiment illustrated in FIG. 3, or the like, and may be changed according to the size, shape, or operation characteristics of the electronic device ED. In an alternative embodiment, some of the support layer SP, the cushion layer CP, the shield layer EMP, and the inter-bonding layer ILP may be omitted, the stack sequence thereof may be changed to a sequence different from FIG. 3, or an additional component other than the illustrated components may be further included, for example. In an embodiment, the lower support member BSM may further include a digitizer, or the like, for example.

The support layer SP may include a metal material or a polymer material. The support layer SP may be disposed under the support plate MP. In an embodiment, the support layer SP may be a thin film-metal substrate, for example.

The support layer SP may include a first sub-support layer SSP1 and a second sub-support layer SSP2 spaced apart from each other in the second directional axis DR2. The first sub-support layer SSP1 and the second sub-support layer SSP2 may be spaced apart from each other with respect to a part corresponding to the folding axis FX1. The support layer SP may be provided as the first sub-support layer SSP1 and the second sub-support layer SSP2 which are spaced apart from each other in the folding region FA, thereby improving the folding or bending characteristics of the electronic device ED.

The cushion layer CP may be disposed under the support layer SP. The cushion layer CP may prevent pressing-down and plastic deformation of the support plate MP caused by external impact and force. The cushion layer CP may improve the impact resistance of the electronic device ED. The cushion layer CP may include an elastomer such as a sponge, a foam, or a urethane resin. In addition, the cushion layer CP may include at least one of an acryl-based polymer, a urethane-based polymer, a silicon-based polymer and an imide-based polymer, but an embodiment of the invention is not limited thereto.

In addition, the cushion layer CP may include a first sub-cushion layer CP1 and a second sub-cushion layer CP2 spaced apart from each other in the second directional axis DR2. The first sub-cushion layer CP1 and the second sub-cushion layer CP2 may be spaced apart from each other in a part corresponding to the folding axis FX1. The cushion layer CP may be provided as the first sub-cushion layer CP1 and the second sub-cushion layer CP2 spaced apart from each other in the folding region FA, thereby improving the folding or bending characteristics of the electronic device ED.

The shield layer EMP may be an electromagnetic wave shielding layer, or a heat-dissipation layer. In addition, the shield layer EMP may function as a bonding layer. The inter-bonding layer ILP may bond the support plate MP and the lower support member BSM. The inter-bonding layer ILP may be provided in a form of a bonding resin layer or an adhesive tape. FIG. 3 illustrates that the inter-bonding layer ILP is divided into two portions spaced apart from each other in a part corresponding to the folding region FA, but an embodiment of the invention is not limited thereto. In an alternative embodiment, the inter-bonding layer ILP may be provided as a single layer which is not spaced apart from each other in the folding region FA.

The filling part SAP may be disposed outside the support layer SP and the cushion layer CP. The filling part SAP may be disposed between the support plate MP and a housing HAU. The filling part SAP may fill the space between the support plate MP and the housing HAU, and may fix the support plate MP.

In addition, the electronic device ED in an embodiment may further include a module adhesive layer AP-DM disposed between the display module DM and the support module SM. The module adhesive layer AP-DM may be an OCA or an OCR. Although not illustrated, an additional adhesive layer may be further disposed between the respective members included in the support module SM.

A through-hole TH may be defined in the support module SM. The through-hole TH may overlap or correspond to the sensing region SA (refer to FIG. 1A) of the electronic device ED. The through-hole TH may be defined so as to overlap the electronic module CM. At least a portion of the electronic module CM may be inserted into the through-hole TH.

In an embodiment, the electronic module CM may be a camera module. The camera module may capture a still image and a video. The camera module may be provided in plural. At least some of the plurality of camera modules may overlap the first region DP-SA of the display module DM. An external input (e.g., light) may be supplied to the camera module through the first region DP-SA. In an embodiment, the camera module may receive natural light through the first region DP-SA, and capture an external image, for example.

In addition, the electronic device ED may include the housing HAU that accommodates the electronic module CM, the display module DM, the support module SM, etc. The housing HAU may be bonded to the window module WM. Although not illustrated, the housing HAU may further include a hinge structure for easily folding or bending.

In the electronic device ED in an embodiment, the entirety of the display module DM, the window module WM, and the upper coating layer CL-T which are stacked may have a haze of about 4.5% or less.

The electronic device ED in an embodiment may include a lower coating layer CL (e.g., CL-B in FIGS. 4A to 4B) having a predetermined thickness or more under the lowermost surface of the display module DM exposed to the electronic module CM, and/or an upper coating layer CL (e.g., CL-T in FIG. 3) on the uppermost surface of the window module WM, which is the display surface FS (refer to FIG. 1A), thereby controlling the haze of the display member EM to about 4.5% or less. Accordingly, the electronic device ED may show improved display quality, improved sensing characteristics of the electronic module CM, excellent imaging quality, etc.

FIGS. 4A and 4B are each cross-sectional views illustrating an embodiment of a part of an electronic device. FIGS. 4A and 4B may be parts corresponding to an embodiment of a display member EM in FIG. 3, etc. Hereinafter, in an electronic device in an embodiment to be described with reference to FIGS. 4A and 4B, the duplicate description made with reference to FIGS. 1A to 3 will not be described again, and the following description will be mainly focused on differences.

FIG. 4A illustrates a display member EM-a, which is a part of an electronic device. The display member EM-a in an embodiment illustrated in FIG. 4A may further include a lower coating layer CL-B, compared to the display member EM (refer to FIG. 3) in the electronic device ED in an embodiment illustrated in FIG. 3. The display member EM-a in an embodiment may include an upper coating layer CL-T on the uppermost portion thereof and the lower coating layer CL-B under the lowermost portion thereof.

In an embodiment, the lower coating layer CL-B may be disposed under a lowermost surface DM-DS of a display module DM. The lower coating layer CL-B may be directly disposed under the lower surface of a lower film LF.

When the lower coating layer CL-B is disposed under the display member EM-a, the lower coating layer CL-B may cover the surface roughness of the lowermost surface DM-DS of the display module DM. The lower coating layer CL-B may have an average thickness t_{CL-B} of about 10 nm to about 10000 nm. When the lower coating layer CL-B has an average thickness t_{CL-B} of less than about 10 nm, the lower coating layer CL-B may not sufficiently cover the roughness of the external surface of the display module DM, thereby not sufficiently achieving improvement in haze. In addition, when the lower coating layer CL-B has an average thickness t_{CL-B} of more than about 10000 nm, the folding characteristics of an electronic device may be deteriorated due to the great thickness.

When the lower coating layer CL-B is disposed under the display member EM-a, the lower coating layer CL-B may have a refractive index between the refractive index of air and the refractive index of the lowermost layer of the display module DM in direct contact with the lower coating layer CL-B. In an embodiment, the lower coating layer CL-B may have a refractive index of about 1.0 to about 1.6, for example.

The lower coating layer CL-B may be an organic layer, an inorganic layer, or an organic-inorganic composite material layer. The lower coating layer CL-B may include an acryl-based resin, a siloxane-based resin, or a composite resin derived from a combination thereof. In an embodiment, the lower coating layer CL-B may include a composition for a hard coating layer, for example. However, in an alternative embodiment, the lower coating layer CL-B may not include a scattering body such as inorganic particles to reduce a haze.

The description of the upper coating layer CL-T in the electronic device ED made with reference to FIGS. 2 and 3 may be similarly applied to the upper coating layer CL-T in an embodiment of the display member EM-a illustrated in FIG. 4A.

When the display member EM-a in an embodiment includes both the upper coating layer CL-T and the lower coating layer CL-B, the upper coating layer CL-T and the lower coating layer CL-B may include the same material, but an embodiment of the invention is not limited thereto. The upper coating layer CL-T and the lower coating layer CL-B may include different materials, and may be respectively provided to cover the surfaces of layers adjacent to each other.

The entirety of a stack structure including the display module DM, the window module WM, and the upper and lower coating layers CL-T and CL-B in the electronic device in an embodiment may have a haze of about 4.5% or less. In the electronic device in an embodiment, the display member EM-a includes the lower coating layer CL-B and the upper coating layer CL-T which are respectively disposed under the lowermost surface DM-DS of the display module DM exposed to the electronic module CM, and on the uppermost surface WM-US of the window module WM which is the display surface FS (refer to FIG. 1A), and may thus control a haze to about 4.5% or less. Accordingly, the electronic device in an embodiment may show improved display quality, improved sensing characteristics of an electronic module, excellent imaging quality, etc.

FIG. 4B illustrates a display member EM-b, which is a part of an electronic device. The display member EM-b in an embodiment illustrated in FIG. 4B may further include an upper film UF and an upper adhesive layer AP-U, compared to the display member EM-a in an embodiment illustrated in FIG. 4A. The display member EM-b in an embodiment may include the upper coating layer CL-T on the uppermost portion thereof, and the lower coating layer CL-B under the lowermost portion thereof.

In an embodiment, the lower coating layer CL-B may be disposed under the lowermost surface DM-DS of the display module DM-b, and the upper coating layer CL-T may be disposed on the uppermost surface WM-US of the window module WM. The same content as described with reference to FIGS. 2 to 4A may be applied for the upper coating layer CL-T and the lower coating layer CL-B. In addition, the description made with reference to FIGS. 2 to 4A may be also similarly applied to other components of the display module DM and the window module WM.

In the display member EM-b in an embodiment, the display module DM-b may include the upper film UF. The display module DM-b may include the upper film UF disposed on the upper side of the display panel DP, thereby protecting the display panel DP. The upper film UF may be disposed adjacent to the lower side of the window module WM. The upper film UF may be directly disposed under the lower surface of the window adhesive layer AP-W.

In an embodiment illustrated in FIG. 4B, the upper film UF may be disposed on a reflection adjustment layer RCL, but an embodiment of the invention is not limited thereto. In an alternative embodiment in which the reflection adjustment layer RCL is omitted, the upper film UF may be disposed on a sensor layer IS.

The upper adhesive layer AP-U may be disposed under the upper film UF, and bond the upper film UF and a member such as the display panel DP. In an embodiment illustrated in FIG. 4B, the upper adhesive layer AP-U may be disposed between the upper film UF and the reflection adjustment layer RCL, but an embodiment of the invention is not limited thereto. In an alternative embodiment in which the reflection adjustment layer RCL is omitted, the upper adhesive layer AP-U may be disposed between the upper film UF and the sensor layer IS.

The upper film UF may be a polymer film. In an embodiment, the upper film UF may include a PET film or a PI film, for example. The upper film UF may function as an impact absorption layer that protects a component of the display module DM-b disposed thereunder. In addition, the upper film UF may function as an optical layer for improving display quality of an electronic device. The upper film UF may have a structure which has one film layer, or in which a plurality of film layers is stacked.

The upper adhesive layer AP-U may be an OCA or an OCR, but an embodiment of the invention is not limited thereto. The upper adhesive layer AP-U may include an acryl-based adhesive, a silicon-based adhesive, or the like. In addition, in an alternative embodiment, the upper adhesive layer AP-U may be omitted.

In the electronic device in an embodiment, the entirety of the display member EM-b, including the upper film UF and the lower film LF, in which the display module DM-b, the window module WM, and the upper and lower coating layers CL-T and CL-B are stacked may have a haze of about 4.5% or less. Since the electronic device in an embodiment includes the lower coating layer CL-B and the upper coating layer CL-T which are respectively disposed under the lowermost surface DM-DS of the display module DM-b exposed to the electronic module CM, and on the uppermost surface WM-US of the window module WM, which is the display surface FS (refer to FIG. 1A), the display member EM-b may control a haze to about 4.5% or less, thereby showing improved display quality, and improved electronic module performance. In an embodiment, when the electronic module is a camera module, the electronic device in an embodiment may show excellent imaging quality characteristics, for example.

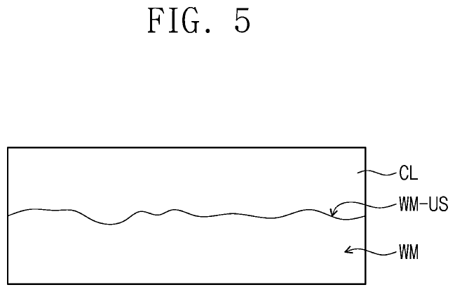

FIG. 5 is a diagram illustrating an embodiment of a part in which a coating layer is disposed. In FIG. 5, a coating layer CL disposed on an uppermost surface WM-US of a window module WM is illustrated as an example. In an embodiment, the coating layer CL may be provided so as to cover the surface roughness of the uppermost surface WM-US of the window module WM. The coating layer CL may be disposed on the window module WM, thereby minimizing light scattering caused by the uneven surface of the uppermost surface WM-US of the window module WM. Accordingly, deterioration of display quality caused by light scattering, and deterioration of imaging quality when using a camera module may be mitigated.

FIG. 5 illustrates, In an embodiment, only a case in which the coating layer CL is disposed on the window module WM, but disposing the coating layer under the display module may also minimize light scattering caused by the uneven surface of the display module. That is, in the electronic device in an embodiment including a coating layer disposed on the external surface of a display member with a predetermined thickness, the coating layer may cover the surface roughness, and therefore the electronic device may have a low haze, thereby showing improved display quality, and excellent operation performance of the electronic module.

The following table 1 shows comparison results between the haze of a display member in an electronic device according to Examples of the invention, and the hazes of a display member in an electronic device according to Comparative Examples. The hazes in Table 1 correspond to the hazes in a visible light region.

In Examples and Comparative Examples compared and evaluated in Table 1, a lower film and a protective layer each correspond to a PET film. In addition, a display panel includes a first region overlapping an electronic module and a second region not overlapping the electronic module.

In Example 1 and Comparative Example 1, in cases in which a lower film is included under a display panel and a protective layer is not included on a window, the hazes according to whether a coating layer exists or not were compared. In Examples 2-1 to 2-3, and Comparative Example 2, in cases in which a lower film is included under a display panel, and a protective layer is included on a window, the hazes according to whether a coating layer exists or not were compared.

TABLE 1

| | | haze |
|---|---|---|
| classification | stack structure | (%) |
| Comparative | window/display panel/lower film | 3.5 |
| Example 1 | | |
| Example 1 | window/display panel/lower film/coating layer | 3.1 |
| Comparative | protective layer/window/display panel/lower film | 4.6 |
| Example 2 | | |
| Example 2-1 | protective layer/window/display panel/lower | 4.2 |
| | film/coating layer | |
| Example 2-2 | coating layer/protective layer/window/display | 4.1 |
| | panel/lower film | |
| Example 2-3 | coating layer/protective layer/window/display | 3.7 |
| | panel/lower film/coating layer | |

Referring to the results of Table 1, it may be confirmed that Examples have a low haze of about 4.5% or less. In addition, referring to the results of Table 1, it may be confirmed that Examples including a coating layer have a more improved haze of a display member than that of Comparative Examples not including a coating layer.

When comparing Example 1 and Comparative Example 1, Example 1 including a coating layer under a lower film included in a display module has a lower haze than that of Comparative Example 1.

When comparing Example 2-1 and Comparative Example 2, Example 2-1 including a coating layer under a lower film included in a display module has a lower haze than that of Comparative Example 2. Example 2-2 including a coating layer on a protective layer included in a window module also has a lower haze than that of Comparative Example 2. In addition, Example 2-3 including a coating layer under a lower film included in a display module, and also including a coating layer on a protective layer included in a window module has a significantly lower haze than that of Comparative Example 2.

That is, referring to the results of Table 1, it may be seen that an electronic device in an embodiment including a coating layer defining an external surface of a display member has a lower haze than a typical electronic device not including a coating layer. Accordingly, an electronic device in an embodiment may show characteristics of mitigating display quality deterioration, imaging quality deterioration, etc., which are caused by light scattering.

An electronic device in an embodiment may include an electronic module, a display module including a display region overlapping the electronic module, and a window module, and may include a coating layer disposed under the lowermost surface of the display module and/or on the uppermost surface of the window module, thereby showing characteristics of mitigating display quality deterioration caused by light scattering and sensing characteristics deterioration of the electronic module caused by light scattering. In addition, since the electronic device in an embodiment may include a camera module as the electronic module, the display module including a display region in which a video is displayed even in a part overlapping the camera module, the window module disposed on the display module, and the coating layer under the lowermost surface of the display module and/or on the uppermost surface of the window module, excellent imaging quality may be ensured even when the display module, etc., is disposed on the path of light incident on or emitting from the electronic module.

An electronic device in an embodiment may include a coating layer on the uppermost part and/or under the lowermost part of stack members disposed on an electronic module, and may thus reduce a haze occurring on the outermost surfaces, thereby showing an effect of mitigating the performance deterioration of the electronic module caused by light scattering.

In the above, description has been made with reference to preferred embodiments of the invention, but those skilled in the art or those of ordinary skill in the relevant technical field may understand that various modifications and changes may be made to the invention within the scope not departing from the spirit and the technology scope of the invention described in the claims to be described later.

Therefore, the technical scope of the invention is not limited to the contents described in the detailed description of the specification, but should be determined by the claims.

What is claimed is:

1. An electronic device comprising:
an electronic module;
a display module including a first region overlapping the electronic module, and a second region not overlapping the electronic module;
a window module disposed on the display module; and
a coating layer disposed on at least one of a first outermost surface of the window module opposite to a second outermost surface of the window module facing the display module and a first outermost surface of the display module opposite to a second outermost surface of the display module facing the window module.

2. The electronic device of claim 1, wherein the coating layer has an average thickness of about 10 nanometers to about 10000 nanometers.

3. The electronic device of claim 1, wherein the coating layer has a refractive index between a refractive index of an outermost layer of the window module including the first outermost surface and a refractive index of air, or between a refractive index of an outermost layer of the display module including the first outermost surface of the display module and the refractive index of air.

4. The electronic device of claim 3, wherein the coating layer has a refractive index of about 1.0 to about 1.6.

5. The electronic device of claim 1, wherein an entirety of the display module, the window module, and the coating layer which are stacked has a haze of about 4.5 percent or less.

6. The electronic device of claim 1, wherein the coating layer comprises an acryl-based resin, a siloxane-based resin, or a composite resin derived from a combination of the a0cryl-based resin and the siloxane-based resin.

7. The electronic device of claim 1, wherein the window module comprises a window, a protective layer disposed on a first surface of the window and including the first outermost surface opposite to the first surface of the window, and a window adhesive layer disposed on a second surface of the window opposite to the first surface of the window and facing the display module, and
the coating layer is disposed on at least one of the first outermost surface of the protective layer and the first outermost surface of the display module.

8. The electronic device of claim 1, wherein the display module comprises a display panel, and a first film disposed on a first surface of the display panel opposite to a second surface of the display panel facing the window module and including the first outermost surface of the display module, and
the coating layer is disposed on at least one of the first outermost surface of the window module and the first outermost surface of the first film.

9. The electronic device of claim 8, wherein the display module further comprises a second film disposed on the second surface of the display panel.

10. The electronic device of claim 9, wherein the first film and the second film are each a polymer film independently including polyethyleneterephthalate or polyimide.

11. The electronic device of claim 1, wherein the display module comprises a display panel, and a first film which is disposed on a first surface of the display panel opposite to a second surface of the display panel facing the window module and includes the first outermost surface of the display module,
the window module comprises a window, a protective layer which is disposed on a first surface of the window and includes the first outermost surface of the window module, and a window adhesive layer disposed on a second surface of the window opposite to the first surface of the window and facing the display module, and
the coating layer comprises a first coating layer disposed on the first outermost surface of the first film and a second coating layer disposed on the first outermost of the protective layer.

12. The electronic device of claim 11, wherein the display module further comprises a second film disposed on the second surface of the display panel.

13. The electronic device of claim 11, wherein the window is a cover window including a glass material, and the protective layer comprises thermoplastic polyurethane, or polyethyleneterephthalate.

14. An electronic device, which is divided into a folding region folded with respect to a folding axis extending in a direction, and a non-folding region adjacent to the folding region, the electronic device comprising:
an electronic module;
a display panel including a first region overlapping the electronic module, and a second region not overlapping the electronic module;
a window module disposed on a first surface of the display panel;
a film disposed on a second surface of the display panel opposite to the first surface of the display panel; and
a coating layer disposed on at least one of a first surface of the window module opposite to a second surface of the window module facing the display panel and a first surface of the film opposite to a second surface of the film facing the window module.

15. The electronic device of claim 14, wherein the coating layer has an average thickness of about 10 nanometers to about 10000 nanometers.

16. The electronic device of claim 14, wherein the coating layer has a refractive index of about 1.0 to about 1.6.

17. The electronic device of claim 14, an entirety of the display panel, the window module, the film, and the coating layer which are stacked has a haze of about 4.5 percent or less.

18. An electronic device comprising:
an electronic module;
a support module in which a through-hole is defined and which overlaps the electronic module; and
a display member disposed on the support module, and including a display module, a window module disposed on the display module, and a coating layer disposed on at least one of a first outermost surface of the window module opposite to a second outermost surface of the window module facing the display module and a first outermost surface of the display module opposite to a second outermost surface of the display module facing the window module,
wherein the display member has a haze of about 4.5 percent or less.

19. The electronic device of claim 18, wherein the display module comprises a display panel, and a film disposed on a first surface of the display panel opposite to a second surface of the display panel facing the window module,
the window module comprises a window including a glass material, a protective layer disposed on a first surface of the window, and a window adhesive layer disposed on a second surface of the window opposite to the first surface of the window and facing the display module, and
the coating layer comprises a first coating layer disposed on a first surface of the protective layer opposite to a second surface of the protective layer facing the display module, and a second coating layer disposed on a first surface of the film opposite to a second surface of the film facing the window module.

20. The electronic device of claim 19, wherein the first coating layer and the second coating layer each have an average thickness of about 10 nanometers to about 10000 nanometers.
